(19) United States
(12) Patent Application Publication
(10) Pub. No.: US 2015/0129587 A1
(43) Pub. Date: May 14, 2015

(54) Resonant Dielectric Heating

(71) Applicant: The Governors of the University of Alberta, Edmonton (CA)

(72) Inventors: Charles William Van Neste, Edmonton (CA); Thomas George Thundat, Edmonton (CA); John Errington Hawk, Edmonton (CA); Tinu Mary Abraham, Edmonton (CA); Jacob H Masliyah, Edmonton (CA); Jonathan Backs, Edmonton (CA); Richard Hull, Edmonton (CA); Arindam Phani, Edmonton (CA)

(21) Appl. No.: 14/537,825

(22) Filed: Nov. 10, 2014

Related U.S. Application Data
(60) Provisional application No. 61/902,037, filed on Nov. 8, 2013.

(51) Int. Cl. H05B 6/62; E21B 43/24; E21B 36/04

(52) U.S. Cl. CPC H05B 6/62; E21B 36/04; E21B 43/2401
USPC 219/772; 219/778

(57) ABSTRACT

Dielectric in situ heating of materials using a resonant, non-radiating transformer. The target material is strategically formed into a part of the capacitance of the resonant system. The system may be used to heat in situ materials such as oilsands.

### CROSS-REFERENCE TO RELATED APPLICATIONS

This application claims the benefit under 35 USC 119(e) of U.S. provisional application Ser. No. 61/902,037 filed Nov. 8, 2013.

### TECHNICAL FIELD

Heating using electric sources.

### BACKGROUND

Dielectric heating is the process of using a high frequency electric source to heat a given object or area possessing a low conductivity. When the electric field of the source impinges on the target, the molecules of the target will align based on their electric dipole moment. With alternating fields, this causes the molecules to rotate back and forth generating heat. The equation for this heating is given by:

P=ω·εᵣ″·ε₀·E² (1)

where ω is the angular frequency of the exciting field, εᵣ″ is the loss portion of the complex relative permittivity of the absorbing material, ε₀ is the permittivity of free space, and E the electric field strength.

It is known to use an extremely high frequency (generally microwave range) source such that the target molecules' rotation is in resonance with the source of high frequency. Such sources generate electromagnetic radiation which places the energy of the source into space. There is then a probability that the energy in space will interact with the molecules of the target and be absorbed—generating heat. This interaction can be inefficient, especially when a uniform heating of a large area is needed, and variations are known that focus on the frequency of excitation, found in the angular frequency term of equation 1 which is a linear property.

### SUMMARY

There is provided a method of generating an alternating electric field in a medium, comprising the steps of connecting a resonant transformer to the medium via electrodes and the resonant transformer applying an alternating voltage to the electrodes at a resonant frequency of the resonant transformer. In various embodiments, there may be included any one or more of the following features: The resonant transformer may be a high voltage output capable of a minimum of at least 100 kV. The resonant transformer may produce an output of greater than 10 million volts in a frequency range between 20 kHz to 2 MHz. The method may further comprise treating the medium to increase a dielectric constant of the medium or to lower a conductivity of the medium. The resonant transformer may be a resonant autotransformer. The medium may be an oil sand. The medium may be a dielectric liquid.

There is provided an apparatus for generating an electric field in a medium, comprising: two electrodes emplaceable within the medium, and a resonant transformer connected to the two electrodes for applying an alternating voltage to the electrodes at a resonant frequency of the resonant transformer. In various embodiments, there may be included any one or more of the following features: The resonant transformer may have a high voltage output capable of a minimum of at least 100 kV. The resonant transformer may be capable of producing an output of greater than 10 million volts in a frequency range between 20 kHz to 2 MHz. The medium may be treated to increase a dielectric constant of the medium or to lower a conductivity of the medium. The resonant transformer may be a resonant autotransformer. The medium may be an oil sand. The medium may be a dielectric liquid.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic diagram showing a system to energize a medium;

FIG. 2 is a circuit diagram of an embodiment of a system for energizing a medium;

FIG. 3 is a circuit diagram of a system similar to the system of FIG. 2 but with a different way of supplying energy to the system;

FIG. 4 is a circuit diagram of a different embodiment of a system for energizing a medium; and

FIG. 5 is a circuit diagram of a system similar to the system of FIG. 4 but with a different way of supplying energy to the system.

### DETAILED DESCRIPTION

There is provided a method of dielectric heating for the in situ heating of materials (i.e. oil sands, tailings water, etc.) using a resonant, non-radiating transformer. The target material is strategically formed into a part of the capacitance of the resonant system. The resonant transformer stores the majority of the input energy with minimal electromagnetic radiation. Dielectric losses in this capacitor produce a uniform heating over the entire target volume with energy being maintained in the system and not in space. A resonant autotransformer comprises a transformer with the primary physically connected to the secondary in one place (just like in a variac). We call it resonant because the transformer will electrically oscillate at specific frequencies (due to transformer action or voltage stepup/stepdown at specific frequencies, specifically due to the resonance with capacitance such as the surrounding stray capacitance).

In an embodiment of this invention, a resonant autotransformer (RAT) is used as a high frequency high voltage source. The target medium is placed between electrodes connected to taps along the RAT. For the in situ heating of oil sands, the electrodes may be driven directly into the ground or coupled to existing infrastructure (i.e. Steam Assisted Gravity Drainage (SAGD) and Cyclic Steam Stimulation (CSS) wells). Ideally, the RAT' s high voltage output should be capable of a minimum of 100 kV and extend up to tens of millions of volts in a frequency range between 20 kHz to several MHz. We can actually build these devices now operating between 1 kHz to 100 MHz.The extreme high voltage at RF frequencies causes a rapid rotational polarization of molecules. This results in volumetric energy dissipation between the electrodes bringing about a uniform temperature rise in the entire region of electric field exposure. Uniform heating of oil sands will be advantageous for the in situ oil sands industry which currently faces problems of low bitumen recovery, longer heating time, high water consumption and high operational costs. This method will also find benefit for the expidited reduction of tailings pond water as the water can be quickly boiled off in large volumes.

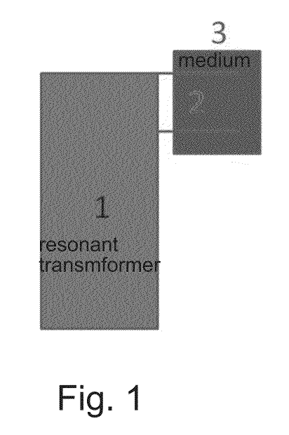

In one embodiment, shown in FIG. 1, a resonant transformer 1 of low internal losses is connected to electrodes 2. Examples of a resonant transformer 1 may include but are not limited to a Tesla coil, Oudin coil, tank circuit, power electronics converter, etc. A target medium 3 is placed between electrodes 2. Target medium 3 may ideally have a relatively high dielectric constant and a relatively low conductivity. In the case that target medium 3 is not optimum, additives may be placed in target medium 3 such that it approaches the more ideal condition. Additives may include but are not limited to impurities, polymers, gaps, separations, etc. By applying an alternating frequency at the resonant frequency of the resonant transformer 1, energy per cycle is stored inside the system and very little energy is placed in space. The storage of energy generates extremely high electric field magnitudes through passive resonant rise which drives the molecular dipole moment of target medium 3 into rotation.

In a second embodiment, the same arrangement as embodiment 1 is used except that resonant transformer 1 is a resonant autotransformer whose internal input resistive losses are made extremely small and input current very large such that the high voltage output corresponds to the reactance of the coil multiplied by the input current. As an illustrative example, if the input resistance is 0.001 Ohm, the reactance of the resonant autotransformer is 20,000 Ohms, and the input current is 100 Amps, the high voltage output will be nearly 2,000,000 Volts. The wire resistance losses will be the input current squared multiplied by the input resistance yielding an operational power loss of only 10 Watts to produce 2 MV. All other power consumed in the system will therefore be in the dielectric loss of the target medium 3. Uniform heating of the target medium 3 will be generated when the operating frequencies are kept in the low to very low radio frequency band and the efficiency of the heating will be high.

In a third embodiment, the same arrangement as embodiment 1 and 2 is used except the target medium 3 is an oil sand. The system may then be operated alone or in tandem with existing industry infrastructure (Steam Assisted Gravity Drainage (SAGD) and Cyclic Steam Stimulation (CSS) wells, etc.) to reduce water consumption and to promote greater bitumen extraction.

In a fourth embodiment, the same arrangement as embodiment 1 and 2 is used except target medium 3 is a dielectric liquid such as (but not limited to) water. The water may be quickly converted to steam. Such steam may then be used to produce propulsion, energy conversion, desalination, purification, etc.

In a fifth embodiment, the same arrangement as embodiment 1 and 2 is used except target medium 3 is tailings pond water where the water is raised in temperature to reduce evaporation time for tailings pond recovery.

The following advantages are anticipated to be obtainable by embodiments of the invention: The volume of heating is confined between electrodes resulting in uniform heating of the region between electrodes. The high electric field produced can cause faster heating of the reservoir. Radiofrequency energy doesn't have penetration depth issues unlike microwave energy. It can be coupled with the existing Steam Assisted Gravity Drainage (SAGD) and Cyclic Steam Stimulation (CSS) wells, so that they behave like electrodes which results in uniform heating of the region between the wells. This would result in reduced water consumption for heating oil sands and integration with existing systems would result in cost effectiveness. The technology can solve problems related to water consumption in current extraction method of SAGD and CSS. The process would be energy efficient, require less time of heating and result in more uniform heating of reservoir than is happening by current process. It treats the reservoir like a capacitor, resulting in capacitive heating of the reservoir.

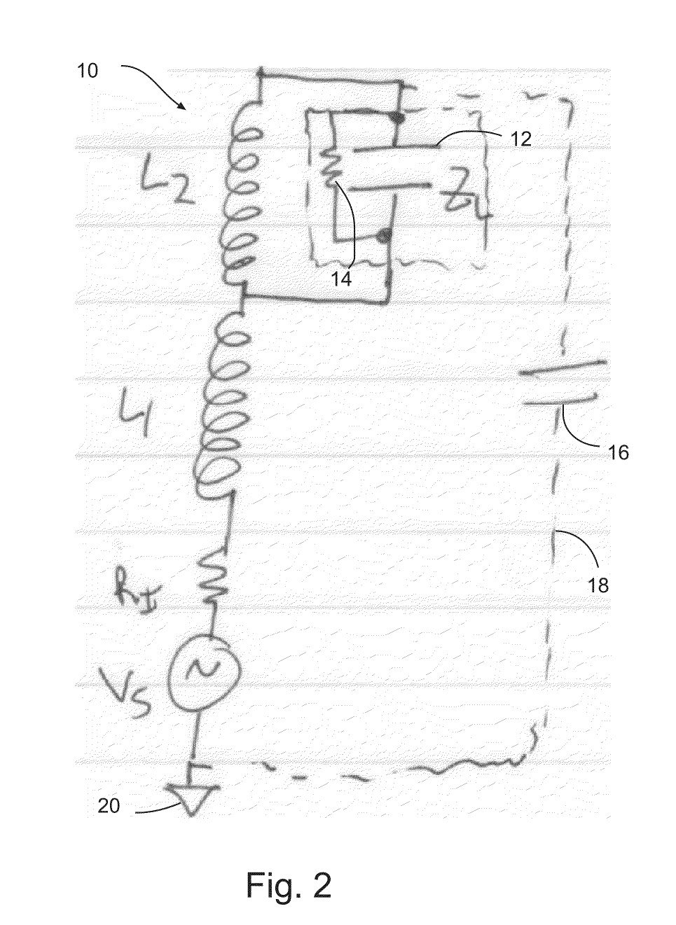

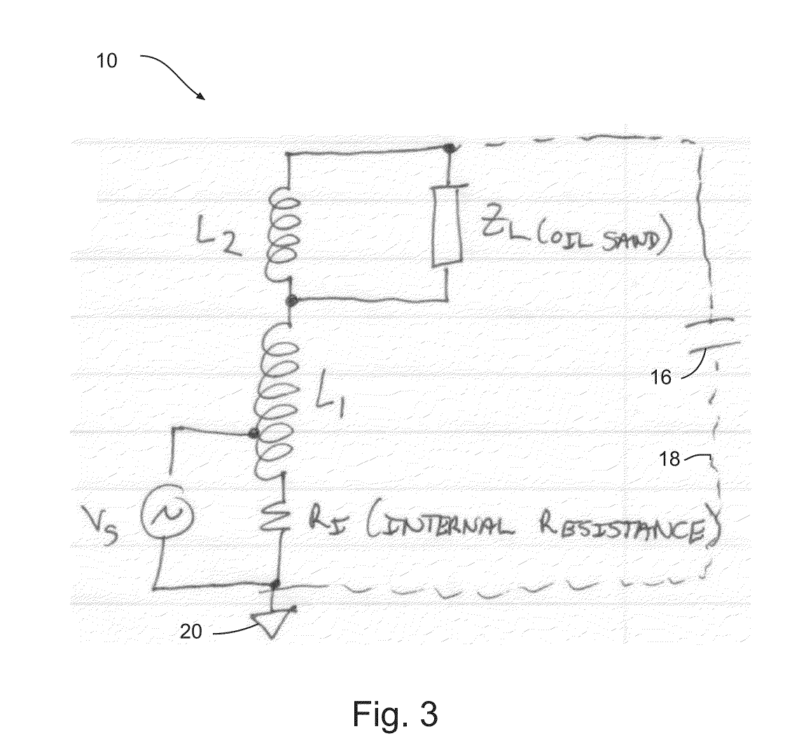

FIG. 2 is a circuit diagram of an embodiment of a system 10 for energizing a medium. As shown in FIG. 2 a power source V_{S} with internal resistance R_{I} energizes an inductance comprising two components L₁ and L₂. The power source as shown supplies a voltage with respect to ground 20. A load impedance Z_{L} here comprises a capacitance 12 and resistance 14 in parallel, although typically these are not separate elements but represent characteristics of a medium, for example an oil sand. Different media may have different electrical characteristics. The load impedance Z_{L} is connected in parallel with L₂. Stray capacitance 16 completes the circuit, but dotted lines 18 indicate that there is in fact no direct (e.g. wired) connection. The stray capacitance of an object represents the capacitance that an object has with respect to a reference (e.g. a ground). The inductive and capacitive elements of the circuit shown in FIG. 2 allow a resonance to occur. The resonance is energized by the source allowing voltages to be developed within the resonant circuit which can be much larger than the voltage of the source depending on the properties of the resonance and the tuning of the source. The load impedance is included in the circuit and will in general affect the properties of the resonance, so the frequency of the source should be tuned to energize the resonance of the circuit including the load impedance. The inductance shown in FIG. 2 may be a main inductor of a resonant autotransformer with L₂ being a tapped portion of the main inductor. FIG. 3 shows an alternative version of the system of FIG. 2 in which the source is connected across a portion of the inductance L₁. This is another way the source can energize the resonance.

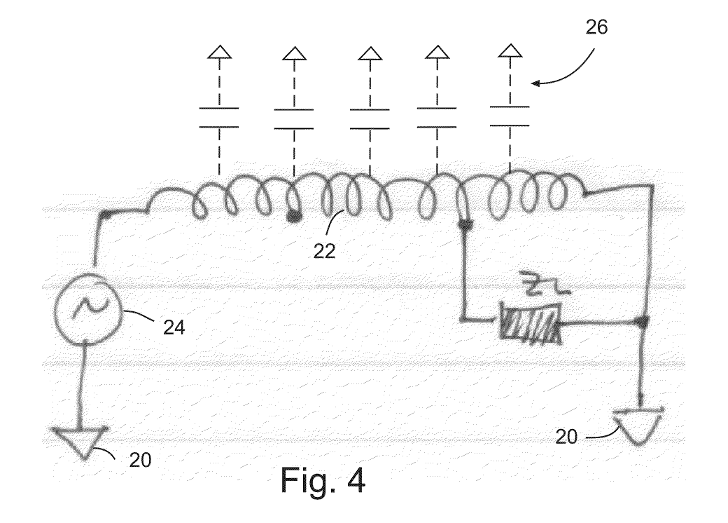

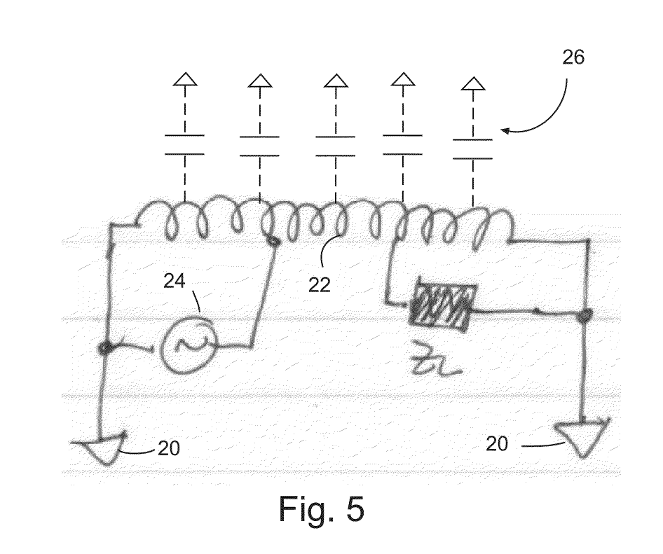

FIG. 4 shows another embodiment of a system for oil sands heating. In the system of FIG. 4 two ends are both connected to ground 20. A stray capacitance 26 of the inductor 22 provides a distributed capacitance that allows a resonance forming a standing wave along the inductor. Load impedance Z_{L} connected across a portion of the inductance 22 is energized by the standing wave. As in FIG. 2, the characteristics of the resonance are in general affected by the load impedance. Source 24 is connected to supply a voltage to one end of the inductance 22 to energize the resonance. FIG. 5 shows an alternative version of the system of FIG. 4 in which the source is connected across a portion of the inductance 22 to energize the resonance.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of generating an alternating electric field in a medium, comprising the steps of:
connecting a resonant transformer to the medium via electrodes; and
the resonant transformer applying an alternating voltage to the electrodes at a resonant frequency of the resonant transformer.

2. The method of claim 1 in which the resonant transformer has a high voltage output capable of a minimum of at least 100 kV.

3. The method of claim 1 in which the resonant transformer can produce an output of greater than 10 million volts in a frequency range between 20 kHz to 2 MHz.

4. The method of claim 1 further comprising treating the medium to increase a dielectric constant of the medium or to lower a conductivity of the medium.

5. The method of claim 1 in which the resonant transformer is a resonant autotransformer.

6. The method of claim 1 in which the medium is an oil sand.

7. The method of claim 1 in which the medium is a dielectric liquid.

8. An apparatus for generating an electric field in a medium, comprising:
two electrodes emplaceable within the medium;
a resonant transformer connected to the two electrodes for applying an alternating voltage to the electrodes at a resonant frequency of the resonant transformer.

9. The apparatus of claim 8 in which the resonant transformer has a high voltage output capable of a minimum of at least 100 kV.

10. The apparatus of claim 9 in which the resonant transformer can produce an output of greater than 10 million volts in a frequency range between 20 kHz to 2 MHz.

11. The apparatus of claim 10 in which the two electrodes are placed within the medium and the medium has been treated to increase a dielectric constant of the medium or to lower a conductivity of the medium.

12. The apparatus of claim 8 in which the resonant transformer is a resonant autotransformer.

13. The method of claim 8 in which the medium is an oil sand.

14. The method of claim 8 in which the medium is a dielectric liquid.

15. The apparatus of claim 8 in which the two electrodes are placed within the medium and the medium has been treated to increase a dielectric constant of the medium or to lower a conductivity of the medium.

16. The apparatus of claim 15 in which the resonant transformer is a resonant autotransformer.

17. The apparatus of claim 16 in which the medium is an oil sand.

18. The apparatus of claim 15 in which the medium is an oil sand.

19. The apparatus of claim 15 in which the medium is a dielectric liquid.
